(19) United States
(12) Patent Application Publication
(10) Pub. No.: US 2022/0113715 A1
(43) Pub. Date: Apr. 14, 2022

(54) PREDICTIVE MAINTENANCE METHOD FOR DEVICE BY MEANS OF CONTROL OUTPUT SIGNAL

(71) Applicant: ITS CO., LTD., Ulsan (KR)

(72) Inventor: Young Kyu Lee, Ulsan (KR)

(21) Appl. No.: 17/559,056

(22) Filed: Dec. 22, 2021

Related U.S. Application Data
(63) Continuation of application No. PCT/KR2020/007279, filed on Apr. 6, 2020.

(30) Foreign Application Priority Data
Jun. 25, 2019 (KR) 10-2019-0075809

(51) Int. Cl. G05B 23/02

(52) U.S. Cl. CPC G05B 23/0235; G05B 23/0221; G05B 23/0283

(57) ABSTRACT

The present invention relates to a predictive maintenance method for a device by means of a control output signal and it is possible to collect operation information of a device in a normal state and operation information of the device before a malfunction occurs, set a suspect value based on the collected information, and if a condition in which an anomaly in the device is suspected is satisfied by comparing a collected value in accordance with operational information collected in real time with the suspect value, issue an warning to induce a service and replacement of the device at an appropriate time, to prevent huge losses of money due to device malfunction in advance.

### CROSS-REFERENCE TO RELATED APPLICATIONS

The present application is a bypass continuation application of currently pending international application No. PCT/KR2020/007279 having an international filing date of Jun. 4, 2020 and designating the United States, the international application claiming a priority date of Jun. 25, 2019 based upon prior filed K.R patent application No. 10-2019-0075809, the entire contents of the aforesaid international application and the aforesaid K.R. patent application being incorporated herein by reference.

### BACKGROUND

The present invention relates to a predictive maintenance method for a device by means of a control output signal, and more particularly, to a predictive maintenance method for a device by means of a control output signal which collects operation information of a device in a normal state and operation information of the device before a malfunction occurs, sets a suspect value based on the collected information, and if a condition in which an anomaly in the device is suspected is satisfied by comparing a collected value in accordance with operational information of the device collected in real time with the suspect value, issues an warning to induce a service and replacement of the device at an appropriate time, thereby preventing huge losses of money due to device malfunction in advance.

Generally, stable operation is very important for various devices used for an automation process of equipment.

For example, dozens or hundreds of devices are installed in the equipment of large-scale production plants to continuously produce products while interlocking with each other. If any one of the plurality of devices is broken, a tremendous situation in which the entire operation of the equipment is stopped may occur.

In this case, due to the down-time caused by the malfunction of the device, a huge loss may be caused by not only the repair cost of the device, but also the operating cost which is wasted while the equipment is stopped and the business effect.

According to the recent data of the Ministry of Employment and Labor and the Korea Occupational Safety and Health Agency, the total number of casualties resulting from annual industry safety accidents is estimated to be about 100,000 and when it is converted into the cost, it is estimated that 18 trillion won is lost annually.

As a way to avoid such unexpected down-time costs, it is urgent to introduce a predictive maintenance system. Even though there was an effort to improve the problems in the name of predictive maintenance, for more effective predictive maintenance, it is necessary to develop a more advanced predictive maintenance method.

### SUMMARY OF INVENTION

The present invention is proposed to solve various problems described above and an object thereof is to provide a predictive maintenance method for a device by means of a control output signal which collects operation information of a device in a normal state and operation information of the device before a malfunction occurs, sets a suspect value based on the collected information, and if a condition in which an anomaly in the device is suspected is satisfied by comparing a collected value in accordance with operational information collected in real time with the suspect value, issues an warning to induce a service and replacement of the device at an appropriate time, to prevent huge losses of money due to device malfunction in advance.

Further, another object is to provide a predictive maintenance method of a device by means of a control output signal which presents various detection conditions to efficiently search for an anomaly generated in a device and detects the device which satisfies the detection condition as an abnormal state not only to very precisely and effectively detect the anomaly occurring in the device, but also to ensure excellent reliability of the detection result.

In order to achieve the object as described above, a perspective maintenance method of a device by means of a control output signal includes a first base information collecting step S10 of measuring and collecting a time interval between a control output signal output from a controller to allow a device which operates with a control output signal output from the controller to repeat an operation in a normal state and a subsequent control output signal, a second base information collecting step S20 of measuring and collecting a time interval between a control output signal output from the controller to allow the device which operates with the control output signal output from the controller to repeat the operation in a state before a malfunction of a device occurs and a subsequent control output signal, a setting step S30 of setting a first suspect value for the time interval between the control output signal and the subsequent control output signal based on the time interval information collected in the first and second base information collecting steps S10 and S20, and a detecting step S40 of measuring and collecting a time interval between a control output signal output from the controller to repeatedly perform the operation of the device in real time and a subsequent output signal and detecting the device as in an abnormal state if the collected time interval value exceeds the first suspect value.

Further, in the first and second base information collecting steps S10 and S20, a time consumed from a time at which one operation of the device starts to an end time is further measured and collected.

In the setting step S30, a second suspect value for the time consumed for one operation is set based on the time information collected in the first and second base information collecting step.

In the detecting step S40, a time consumed from a time when one operation of the device which receives a control output signal output from the controller to perform an operation of the device in real time to operate starts to an end time is measured and collected and when the collected time value exceeds the second suspect value, the device is detected as in an abnormal state.

Further, the first and second suspect values are set to be divided into a warning value and a danger value and the warning value is set to be smaller than the danger value.

When the time interval value and the time value collected in the device in real time exceed the warning values of the first and second suspect values in the detecting step S40, respectively, the device is recognized as in a warning state.

When the time interval value and the time value collected in the device in real time exceed the danger values of the first and second suspect values, respectively, the device is recognized as in a danger state which has a higher level of malfunction dangerousness of the device than the warning state.

Further, in the setting step S30, a danger detecting section for a predetermined time including two or more operations of the device is set.

In the danger detection section set in the detecting step s40, the number of times that a time interval value or a time value or a time interval value and the time value of the device exceed the warning values of the first and second suspect values is counted and when the number of times exceeds the number of times set in the setting step S30, the device is recognized to be in a danger state.

Further, the time information that the device is available is input in the setting direction S30.

In the detecting step S40, an average usage time of the device for one day or a predetermined period is extracted and an available period in which the device is available at the present time is detected and provided based on the extracted average usage time information.

Further, instead of measuring and collecting the time interval between the control output signal and the subsequent control output signal which are repeatedly output from the controller, in the first and second base information collecting steps S10 and S20, a time interval from a time at which one operation starts in the device to a time at which a subsequent operation starts is measured and collected.

In the setting step S30, a third suspect value for the time interval from a time for one operation of the device to a time at which a subsequent operation starts is set based on the time interval information collected in the first and second base information collecting steps S10 and S20.

In the detecting step S40, a time interval from a time at which one operation of the device which repeats an operation starts to a time at which a subsequent operation starts is measured and collected based on the control output signal output from the controller in real time and when the collected time interval value exceeds the third suspect value, the device is detected as in an abnormal state.

As described above, according to the predictive maintenance method for a device by means of a control output signal according to the present invention, it is possible to collect operation information of a device in a normal state and operation information of the device before a malfunction occurs, set a suspect value based on the collected information, and if a condition in which an anomaly in the device is suspected is satisfied by comparing a collected value in accordance with operational information collected in real time with the suspect value, issue an warning to induce a service and replacement of the device at an appropriate time, to prevent huge losses of money due to device malfunction in advance.

Further, various detection conditions to efficiently search for an anomaly generated in a device are presented and if the detection condition is satisfied, the device is detected as in an abnormal state not only to very precisely and effectively detect the anomaly, but also to ensure excellent reliability of the detection result.

### DESCRIPTION OF DRAWINGS

FIG. 1 illustrates a block diagram of a predictive maintenance method of a device by means of a control output signal according to an exemplary embodiment of the present invention.

FIG. 2 is a view illustrating a first base information collecting step according to an exemplary embodiment of the present invention.

FIG. 3 is a view illustrating a second base information collecting step according to an exemplary embodiment of the present invention.

FIG. 4 is a view illustrating a detecting step according to an exemplary embodiment of the present invention.

FIG. 5 is a view illustrating first and second base information collecting step according to an exemplary embodiment of the present invention.

FIG. 6 is a view illustrating first and second base information collecting step according to an exemplary embodiment of the present invention.

FIG. 7 is a view illustrating a device state detecting method based on a second suspect value according to an exemplary embodiment of the present invention.

FIG. 8 is a view illustrating a process of detecting a state of a device by means of a danger detection section based on a time value consumed for an operation of the device according to an exemplary embodiment of the present invention.

FIG. 9 is a view illustrating a process of detecting a state of a device by means of a danger detection section based on a time value consumed for an operation of the device and a time interval value between control output signals output from a controller, according to an exemplary embodiment of the present invention.

FIG. 10 is a view illustrating a device abnormal state detecting method based on a third suspect value according to an exemplary embodiment of the present invention.

FIG. 11 is a view illustrating a device abnormal state detecting method based on a third suspect value according to an exemplary embodiment of the present invention.

The technology to be described below may be modified in various forms and has various exemplary embodiments, and thus specific exemplary embodiments will be illustrated in the drawings and described in detail in detailed description. However, this does not limit the technology to be described below within the specific exemplary embodiments, and it should be understood that the present invention covers all the modifications, equivalents and replacements within the technical spirit and technical scope to be described below.

Terms such as first, second, A, or B may be used to describe various components but the components are not limited by the above terms and are used only to distinguish one component from the other component. For example, without departing from the scope of the technology to be described below, a first component may be referred to as a second component, and similarly, a second component may be referred to as a first component. A term of and/or includes a combination of a plurality of related elements or any one of the plurality of related elements. For example, “A and/or B” may be interpreted as “at least one of A and B”.

Unless the context apparently indicates otherwise, it should be understood that the singular expression includes plural expression. Further, it should be understood that terms “include” indicate that a feature, a number, a step, an operation, a component, a part or the combination thoseof described in the specification is present, but do not exclude a possibility of presence or addition of one or more other features, numbers, steps, operations, components, parts or combinations thereof.

Prior to a detailed description for the drawings, it is intended to clarify that the components in the present specification are merely classified according to a main function of each component. That is, two or more components to be described below may be combined as one component or one component may be divided into two or more components for every subdivided function. Further, each component to be described below may further perform a part or all of the function, which is performed by the other component, as well as a main function to be performed by itself and a partial function of the main function of each component may be exclusively performed by the other component.

When a method or an operating method is performed, processes which constitute the method may be performed in a different order from the mentioned order unless a specific order is clearly mentioned in context. That is, the processes may be performed in the order as described or simultaneously, or an opposite order.

### DETAILED DESCRIPTION

A predictive maintenance method for a device by means of a control output signal according to a preferred exemplary embodiment of the present invention will be described in detail based on the accompanying drawings. A detailed description of known functions and configurations determined to unnecessarily obscure the gist of the present invention will be omitted.

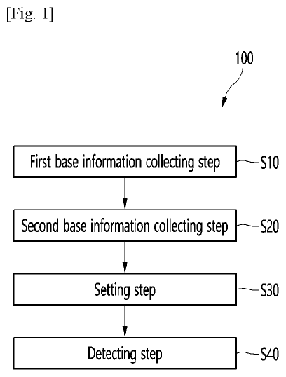

FIG. 1 illustrates a block diagram of a predictive maintenance method of a device by means of a control output signal according to an exemplary embodiment of the present invention.

As illustrated in FIG. 1, the precise predictive maintenance method 100 for a device by means of a control output signal according to an exemplary embodiment of the present invention includes a first base information collecting step S10, a second base information collecting step S20, a setting step S30, and a detecting step S40.

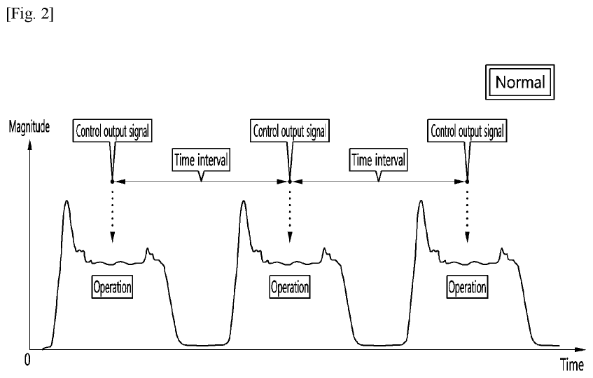

FIG. 2 is a view illustrating a first base information collecting step according to an exemplary embodiment of the present invention.

The first base information collecting step S10 is a step of measuring and collecting a time interval between a control output signal output from the controller to allow a device which operates with a control output signal output from the controller to repeat an operation in a normal state and a subsequent control output signal.

Generally, in order to repeat an operation, the device receives repeated control output signals from the controller. As illustrated in FIG. 2, in the first base information collecting step S10, a time interval between control output signals which are repeatedly transmitted to a device which normally operates is measured and collected and the time interval information collected as described above becomes a basis of a first suspect value set to detect an anomaly of the device in the setting step S30 to be described below.

Here, FIG. 2 illustrates an example of a drilling machine in a normal state which repeatedly performs an operation of continuously drilling holes by receiving a control output signal output from the controller and a waveform illustrated in FIG. 2 illustrates an energy (power) value consumed during the process of performing an operation by the device over time.

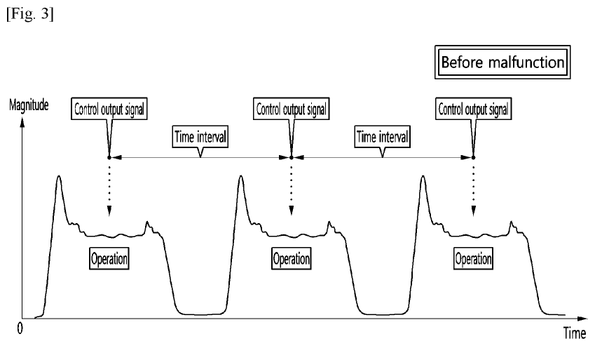

FIG. 3 is a view illustrating a second base information collecting step according to an exemplary embodiment of the present invention.

The second base information collecting step S20 is a step of measuring and collecting a time interval between a control output signal output from the controller to allow the device which operates with the control output signal output from the controller to repeat the operation in a state before a malfunction of a device occurs and a subsequent control output signal.

The time interval values between the control output signals collected and extracted in the second base information collecting step S20 become a basis of the first suspect value set to detect an anomaly of the device in the setting step S30 together with the time interval value collected in the first base information collecting step S10.

Here, it is understood that the time interval between the control output signals output from the controller to control the operation of the device illustrated in FIG. 3 is longer than the time interval between the control output signals output from the controller to control an operation of the device illustrated in FIG. 2. By doing this, it is assumed that the worse the state of the device, the longer the time consumed for an operation performed by the device so that the time between the control output signals output from the controller is also naturally increased.

The setting step S30 is a step of setting a first suspect value for the time interval between the control output signal and the subsequent control output signal based on the time interval information collected in the first and second base information collecting steps S10 and S20.

Here, the first suspect value is set based on values at which time interval values abnormally change (increase) before the malfunction of the device occurs, based on the time information collected for a long time in the first and second information collecting steps S10 and S20.

The first suspect value of the predictive maintenance method 100 for a device by means of a control output signal of the present invention is set to be divided into a warning value and a danger value, but is not limited thereto.

Here, the warning value is set to be smaller than the danger value and the warning value and the danger value will be described in detail in the detecting step S40 to be described below.

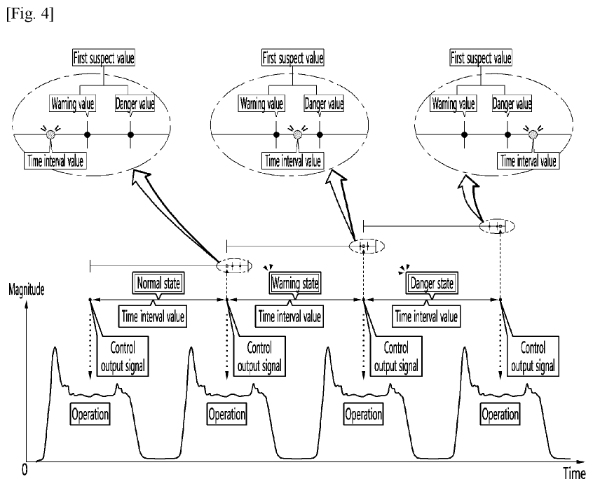

FIG. 4 is a view illustrating a detecting step according to an exemplary embodiment of the present invention.

The detecting step S40 is a step of measuring and collecting a time interval between a control output signal output from the controller to repeatedly perform the operation of the device in real time and a subsequent output signal and detecting the device as in an abnormal state if the collected time interval value exceeds the first suspect value.

Referring to FIG. 4, when the time interval values between the control output signals output from the controller to control the operation of the device in real time do not exceed the warning value or the danger value of the first suspect value, the device is detected as in a normal state. When the time interval values between the control output signals output from the controller exceed the warning value, the device is detected as in a warning state. When the time interval values between the control output signals output from the controller exceed the danger value, the device is detected as in a danger state.

Here, the warning value indicates a lower level of malfunction dangerousness than the danger value, a warning state of the device is a degree to which attention and caution of the device are required, and a dangerous state of the device is a degree to which repair, inspection, or replacement of the device is required.

Therefore, the anomaly of the device is detected in advance based on the state of the device which is detected in real time in the detecting step S40 to prevent an economic loss caused when the entire operation of the equipment is stopped due to the sudden malfunction of the device in advance.

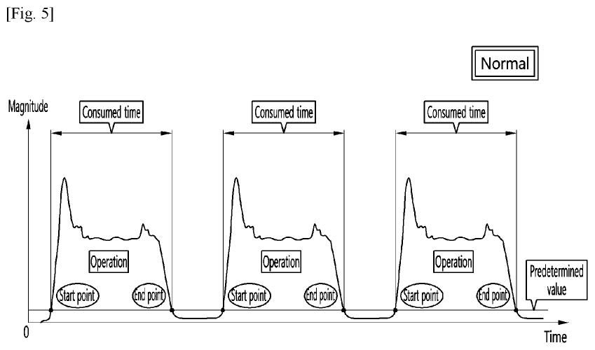

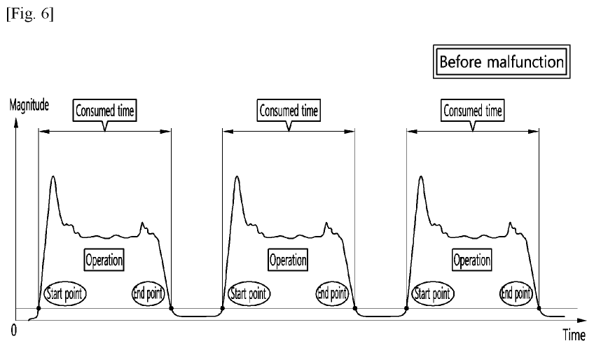

FIGS. 5 and 6 are views illustrating first and second base information collecting step according to an exemplary embodiment of the present invention.

As illustrated in FIGS. 5 and 6, in the first and second base information collecting steps S10 and S20, a time consumed from a time at which one operation of the device starts to a time at which the operation ends may be further measured and collected.

Hereinafter, for the convenience of description, an energy (power) value consumed during a process of performing one operation by a device is illustrated in a waveform over time and the time consumed for one operation of the device is measured and collected with a time when the energy value is increased to be more than a predetermined value as an operation start time and a time when the energy value is lowered to be lower than a predetermined as an end time. However, it is not limited to this method to measure the time consumed for the operation of the device.

In the setting step S30, a second suspect value for the time consumed for one operation is set based on the time information collected in the first and second base information collecting steps.

In the detecting step S40, a time consumed from a time at which one operation of the device which receives a control output signal output from the controller to perform an operation of the device in real time to operate starts to an end time is measured and collected and when the collected time value exceeds the second suspect value, the device is detected as in an abnormal state.

Here, the second suspect value is set to be divided into a warning value and a danger value, like the first suspect value, and at this time, the warning value is set as a value smaller than the danger value.

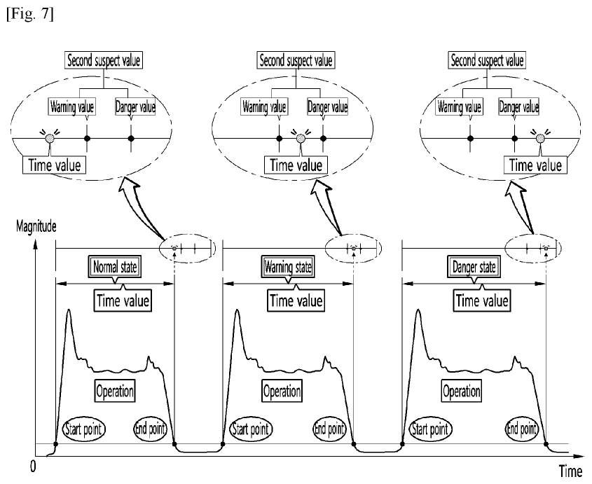

FIG. 7 is a view illustrating a device state detecting method based on a second suspect value according to an exemplary embodiment of the present invention.

Referring to FIG. 7, when the time value consumed for the operation of the device in real time does not exceed the warning value or the danger value of the second suspect value, the device is detected as in a normal state and when the time value consumed for the operation of the device exceeds the warning value, the device is detected as in a warning state, and when the time value consumed for the operation of the device exceeds the danger value, the device is detected as in a danger state.

Here, the warning value indicates a lower level of malfunction dangerousness than the danger value, a warning state of the device is a degree to which attention and caution of the device are required, and a dangerous state of the device is a degree to which repair, inspection, or replacement of the device is required.

Therefore, the anomaly of the device is detected in advance based on the state of the device which is detected in real time in the detecting step S40 to prevent an economic loss generated when the entire operation of the equipment is stopped due to the sudden malfunction of the device in advance.

In the meantime, in the setting step S30, a danger detection section for a predetermine time including two or more operations of the device is set.

In the danger detection section set in the detecting step s40, the number of times that a time interval value or a time value or a time interval value and the time value of the device exceed the warning values of the first and second suspect values is counted and when the number of times exceeds the number of times set in the setting step, the device is recognized as in a danger state.

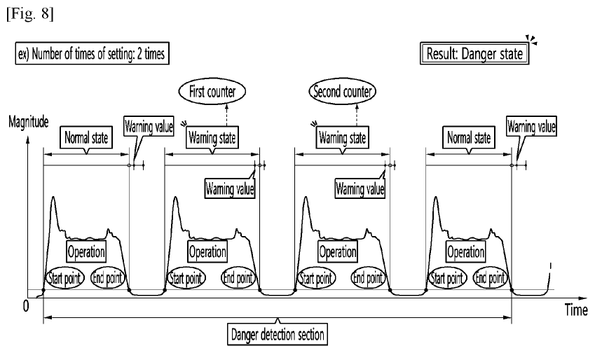

FIG. 8 is a view illustrating a process of detecting a state of a device by means of a danger detection section based on a time value consumed for an operation of the device according to an exemplary embodiment of the present invention.

As illustrated in FIG. 8, in the setting step S30, a section including four times of operation of the device is set as the danger detection section. When the number of settings is set to two times, if a time value consumed for the operation of the device in real time in the danger detection section in the detecting step S40 exceeds a warning value of the first suspect value, the counting is performed. When the number of counters is counted to be equal to or larger than two times which are set in the setting step S30, the device is recognized as in a danger state to induce the predictive maintenance by precise inspection and replacement.

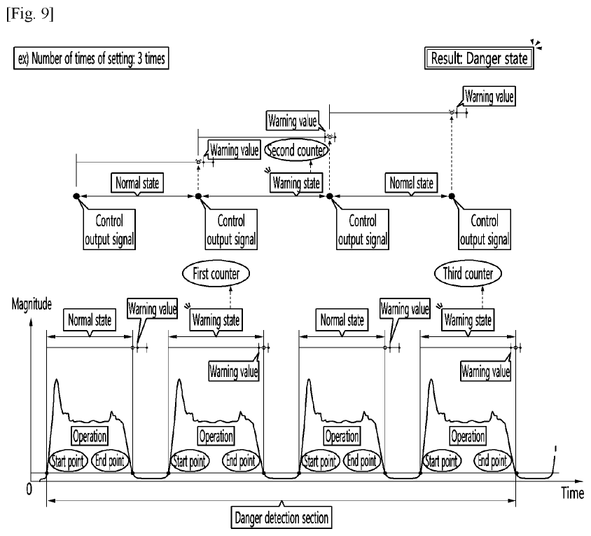

FIG. 9 is a view illustrating a process of detecting a state of a device by means of a danger detection section based on a time value consumed for an operation of the device and a time interval value between control output signals output from a controller, according to an exemplary embodiment of the present invention.

As illustrated in FIG. 9, in the setting step S30, a section including four times of operation of the device is set as the danger detection section. When the number of settings is set to 3 times, if a time value consumed for the operation of the device in real time in the danger detection section in the detecting step S40 exceeds a warning value of the first suspect value, the counting is performed and simultaneously, when the time interval value between control output signals output from the controller exceeds the warning value of the second suspect value, the counting is performed. When a total number of counters is counted to be equal to or larger than three times set in the setting step S30, the device is recognized as in a danger state to induce the predictive maintenance by precise inspection and replacement.

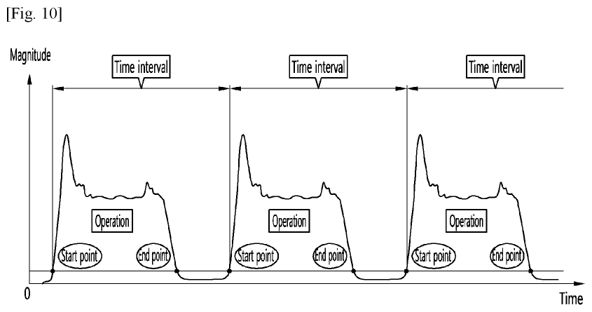

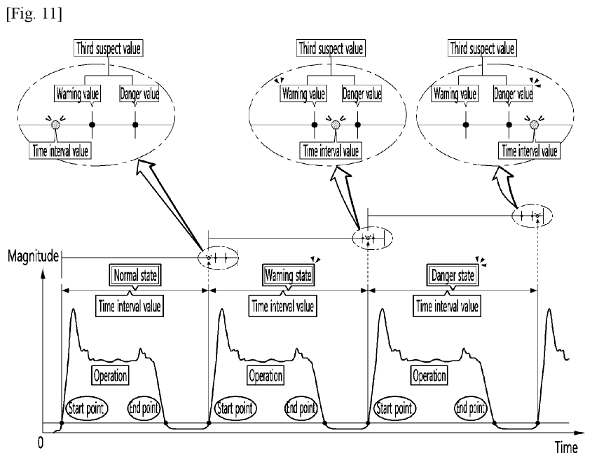

FIGS. 10 and 11 are views illustrating a device abnormal state detecting method based on a third suspect value according to an exemplary embodiment of the present invention.

Referring to FIG. 10, instead of measuring and collecting the time interval between the control output signal and the subsequent control output signal which are repeatedly output from the controller, in the first and second base information collecting steps S10 and S20, a time interval from a time at which one operation starts in the device to a time at which a subsequent operation starts is measured and collected.

In the setting step S30, a third suspect value for the time interval from a time for one operation of the device to a time at which a subsequent operation starts is set based on the time interval information collected in the first and second base information collecting steps S10 and S20.

In the detecting step S40, a time interval from a time at which one operation of the device which repeats an operation starts to a time at which a subsequent operation starts is measured and collected based on the control output signal output from the controller in real time and when the collected time interval value exceeds the third suspect value, the device is detected as in an abnormal state.

Here, the third suspect value is set to be divided into a warning value and a danger value, like the first and second suspect values, and at this time, the warning value is set as a value smaller than the danger value.

Referring to FIG. 11, when the time interval value from the time at which the operation of the device starts in real time to the time at which the subsequent operation starts does not exceed the warning and danger values of the third suspect value, the device is detected as in a normal state, when the time interval value exceeds the warning value, the device is detected as in a warning state and when the time interval value exceeds the danger value, the device is detected as in a danger state.

Therefore, the anomaly of the device is detected in advance based on the state of the device which is detected in real time in the detecting step S40 to prevent an economic loss caused when the entire operation of the equipment is stopped due to the sudden malfunction of the device in advance.

In the meantime, the time information that the device is available is input and set in the setting step S30.

In the detecting step S40, an average usage time of the device for one day or a predetermined period is extracted and an available period in which the device is available at the present time is detected and provided based on the extracted average usage time information.

Generally, the device has an average service life. When the average service life is converted into a time to set in the setting step S30, the average usage amount of the device is measured to detect a device available period (time) in the detecting step S40 to provide the device available period to a manager. Therefore, the manager may clearly recognize an approximate service life of the device so that it is possible to efficiently design a long-term plan for device replacement to induce stable management of the equipment.

As described above, according to the predictive maintenance method 100 for a device by means of a control output signal which detects the anomaly of the device through the above-described process, it is possible to collect operation information of a device in a normal state and operation information of the device before a malfunction occurs, set a suspect value based on the collected information, and if a condition in which an anomaly in the device is suspected is satisfied by comparing a collected value in accordance with operational information of the device collected in real time with the suspect value, issue an warning to induce a service and replacement of the device at an appropriate time, to prevent huge losses of money due to device malfunction in advance.

Further, it is possible to present various detection conditions to efficiently search for an anomaly generated in a device and detect the device which satisfies the detection condition as an abnormal state not only to very precisely and effectively detect the anomaly occurring in the device, but also to ensure excellent reliability of the detection result.

Although the predictive maintenance method 100 for a device by means of a control output signal has been described based on the control output signal output from the controller to the device, when the technique is described based on a control input signal which is output from the controller to be input to the device, the same effect may also be expected.

The present invention has been described with reference to the exemplary embodiment illustrated in the drawing, but the exemplary embodiment is only illustrative and the present invention is not limited thereto. Further, it would be appreciated by those skilled in the art that various modifications and equivalent exemplary embodiments may be made. Further, those skilled in the art may modify the present invention without departing from the spirit of the present invention. Accordingly, the scope of claiming the rights of the present invention is not defined within the scope of the detailed description, but may be limited by the following claims and the technical spirit thereof.

The exemplary embodiment according to the present invention may be implemented by various means, for example, a hardware, a firmware, a software, and a combination thereof. When the exemplary embodiment is implemented by the hardware, one exemplary embodiment of the present invention may be implemented by one or more of application specific integrated circuits (ASICs), digital signal processors (DSPs), digital signal processing devices (DSPDs), programmable logic devices (PLDs), field programmable gate arrays (FPGAs), processors, controllers, microcontrollers, or microprocessors.

Further, in the case of the implementation by firmware or software, the exemplary embodiment of the present invention may be implemented in the form of a module, a procedure, or a function which performs functions or operations described above to be recorded in a recording medium which is readable by various computer means. The recording medium may include solely a program instruction, a data file, and a data structure or a combination thereof. The program instruction recorded in the recording medium may be specifically designed or constructed for the present disclosure or known to those skilled in the art of a computer software to be used. For example, the recording medium includes a hardware device which is specifically configured to store or execute a program instruction, such as a magnetic media such as a hard disk, a floppy disk, and a magnetic tape, an optical media such as a compact disk read only memory (CD-ROM) or a digital video disk (DVD), a magneto-optical media such as a floptical disk, a ROM, a random access memory (RAM), and a flash memory. Examples of the program command include not only a machine language code which is created by a compiler but also a high level language code which may be executed by a computer using an interpreter. The hardware device may operate as one or more software modules in order to perform the operation of the present disclosure and vice versa.

Further, the device or the terminal according to the present invention may be driven by an instruction which causes one or more processors to perform the above-described functions and processes. For example, such an instruction may include interpreted instructions such as script instructions of JavaScript or ECMA script instructions, an executable code, or other instructions stored in a computer readable medium. Moreover, the device according to the present invention may be implemented as a distributed type over a network, such as a server farm, or may be implemented in a single computer device.

A computer program (also known as a program, software, software application, script or code) which is installed in the device according to the present invention and executes the method according to the present invention may be written in any form of a programming language including a compiled or interpreted language or a priori or procedural language. It can be deployed in any form including standalone programs, modules, components, subroutines or other units suitable to be used in a computer environment. The computer program does not necessarily correspond to a file of the file system. The program may be stored in a single file provided to a requested program, in multiple interacting files (for example, a file which stores one or more modules, subprograms, or a part of code), or in a part of a file which holds other programs or data (for example, one or more scripts stored in a markup language document). The computer program is located at one site or distributed over a plurality of sites to be deployed to be executed on multiple computers which are interconnected by a communication network or one computer.

For the convenience of description, even though the drawings have been separately described, exemplary embodiments illustrated in the drawings are designed to be merged to implement a new exemplary embodiment. Further, according to the present invention, the configuration and method of exemplary embodiments as described above may not be applied with limitation, but the exemplary embodiments may be configured by selectively combining all or a part of each embodiment such that various modifications may be made.

Preferred exemplary embodiments of the present invention have been illustrated and described above, but the present invention is not limited to the above-described specific exemplary embodiments, it is obvious that various modifications may be made by those skilled in the art, to which the present invention pertains without departing from the gist of the present invention, which is claimed in the claims, and such modification should not be individually understood from the technical spirit or prospect of the present invention.

The present invention may be applied to various device inspection technical fields.

1. A perspective maintenance method of a device by means of a control output signal, the method comprising:
a first base information collecting step S10 of measuring and collecting a time interval between a control output signal output from a controller to allow a device which operates with the control output signal output from the controller to repeat an operation in a normal state and a subsequent control output signal;
a second base information collecting step S20 of measuring and collecting a time interval between a control output signal output from the controller to allow the device which operates with the control output signal output from the controller to repeat an operation in a state before a malfunction of the device occurs and a subsequent control output signal;
a setting step S30 of setting a first suspect value for the time interval between the control output signal and the subsequent control output signal based on the time interval information collected in the first and second base information collecting steps S10 and S20; and
a detecting step S40 of measuring and collecting a time interval between a control output signal output from the controller to repeatedly perform the operation of the device in real time and a subsequent output signal and detecting the device as in an abnormal state if the collected time interval value exceeds the first suspect value.

2. The perspective maintenance method of claim 1, wherein in the first and second base information collecting steps S10 and S20, a time consumed from a time at which one operation of the device starts to an end time is further measured and collected,
in the setting step S30, a second suspect value for the time consumed for one operation is set based on the time information collected in the first and second base information collecting step, and
in the detecting step S40, a time consumed from a time when one operation of the device which receives the control output signal output from the controller to perform the operation of the device in real time to operate starts and an end time is measured and collected and when the collected time value exceeds the second suspect value, the device is detected as in an abnormal state.

3. The perspective maintenance method of claim 2, wherein the first and second suspect values are set to be divided into a warning value and a danger value and the warning value is set to be smaller than the danger value,
when the time interval value and the time value collected in the device in real time exceed the warning values of the first and second suspect values in the detecting step S40, respectively, the device is recognized as in a warning state, and
when the time interval value and the time value collected in the device in real time exceed the danger values of the first and second suspect values, respectively, the device is recognized as in a danger state which has a higher level of malfunction dangerousness of the device than the warning state.

4. The perspective maintenance method of claim 3, wherein in the setting step S30, a danger detecting section for a predetermined time including two or more operations of the device is set, and in the danger detection section set in the detecting step s40, the number of times that the time interval value or the time value or the time interval value and the time value of the device exceed the warning values of the first and second suspect values is counted and when the number of times exceeds the number of times set in the setting step S30, the device is recognized to be in a danger state.

5. The perspective maintenance method of claim 4, wherein the time information that the device is available is input in the setting direction S30 and
in the detecting step S40, an average usage time of the device for one day or a predetermined period is extracted and an available period in which the device is available at the present time is detected and provided based on the extracted average usage time information.

6. The perspective maintenance method of claim 1, wherein instead of measuring and collecting the time interval between the control output signal and the subsequent control output signal which are repeatedly output from the controller, in the first and second base information collecting steps S10 and S20, a time interval from a time at which one operation starts in the device to a time at which a subsequent operation starts is measured and collected,
in the setting step S30, a third suspect value for the time interval from a time for one operation of the device to a time at which a subsequent operation starts is set based on the time interval information collected in the first and second base information collecting steps S10 and S20, and
in the detecting step S40, a time interval from a time at which one operation of the device which repeats an operation starts to a time at which a subsequent operation starts is measured and collected based on the control output signal output from the controller in real time and when the collected time interval value exceeds the third suspect value, the device is detected as in an abnormal state.
